(19) United States
(12) Patent Application Publication
(10) Pub. No.: US 2020/0226637 A1
(43) Pub. Date: Jul. 16, 2020

(54) RECOMMENDATION METHOD AND APPARATUS FOR DELIVERY RESOURCE OF OUTDOOR ADVERTISEMENT, AND STORAGE MEDIUM

(71) Applicant: BAIDU ONLINE NETWORK TECHNOLOGY (BEIJING) CO., LTD., Beijing (CN)

(72) Inventors: Xinyue GAO, Beijing (CN); Yongheng LI, Beijing (CN)

(73) Assignee: BAIDU ONLINE NETWORK TECHNOLOGY (BEIJING) CO., LTD.

(21) Appl. No.: 16/736,967

(22) Filed: Jan. 8, 2020

(30) Foreign Application Priority Data
Jan. 10, 2019 (CN) 201910022471.5

(51) Int. Cl. G06Q 30/02; G06Q 10/08; G06F 7/24

(52) U.S. Cl. CPC G06Q 30/0255; G06F 7/24; G06Q 10/0838; G06Q 30/0261

(57) ABSTRACT

The present disclosure provides a recommendation method and apparatus for a delivery resource of an outdoor advertisement, and a storage medium. The recommendation method includes determining candidate delivery resources according to historical delivery information of a target client and a preset rule; obtaining a historical delivery record of all clients matched with attribute information of the target client, and obtaining a priority of each type of delivery resources in the historical delivery record of all clients; and determining a target delivery resource from the candidate delivery resources according to the priority of each type of delivery resources, and recommending the target delivery resource to the target client.

### CROSS-REFERENCE TO RELATED APPLICATION

The present application is based upon and claims priority to Chinese Patent Application No. 201910022471.5, filed on Jan. 10, 2019, the entirety contents of which are incorporated herein by reference.

### FIELD

The present disclosure relates to a field of advertisement delivery technology, and more particularly to a recommendation method and apparatus for a delivery resource of an outdoor advertisement, and a storage medium.

### BACKGROUND

With the improvement of the social and economic level, there are increasingly number of physical shops and electronic businesses, and competition among the respective businesses is becoming fiercer and fiercer. In order to attract consumers and to improve reputation of the business, each business may usually deliver advertisement via different channels. Outdoor advertisement is a common form for delivering the advertisement.

Delivery resources of the outdoor advertisement are complex. Delivery places of the outdoor resource include downtown streets, traffic lanes, commercial buildings, public transportation, train stations, etc. Ways for displaying advertisement content includes flat printing, displaying in electronic screen, displaying on a video wall, etc. Prices of the delivery resource are different according to different delivery resource positions and different display ways. When a client selects a delivery resource, a number of factors are usually need to be considered, such that the client needs to perform several searching and query operations until a suitable delivery resource is purchased, leading to a long time and a low purchase efficiency.

### SUMMARY

The present disclosure aims to solve one of the technical problems in the related art to at least some extent.

For this, the present disclosure provides a recommendation method and a recommendation apparatus for a delivery resource of an outdoor advertisement, and a non-temporary computer readable storage medium.

Embodiments of the present disclosure provide a recommendation method for a delivery resource of an outdoor advertisement. The recommendation method includes: determining candidate delivery resources according to historical delivery information of a target client and a preset rule; obtaining a historical delivery record of all clients matched with attribute information of the target client, and obtaining a priority of each type of delivery resources in the historical delivery record of all clients; and determining a target delivery resource from the candidate delivery resources according to the priority of each type of delivery resources, and recommending the target delivery resource to the target client.

Embodiments of the present disclosure provide a recommendation apparatus for a delivery resource of an outdoor advertisement. The recommendation apparatus includes: one or more processors; a memory storing instructions executable by the one or more processors; in which the one or more processors are configured to: determine candidate delivery resources according to historical delivery information of a target client and a preset rule; obtain a historical delivery record of all clients matched with attribute information of the target client, and to obtain a priority of each type of delivery resources in the historical delivery record of all clients; determine a target delivery resource from the candidate delivery resources according to the priority of each type of delivery resources; recommend the target delivery resource to the target client.

Embodiments of the present disclosure provide a non-temporary computer readable storage medium having a computer program stored thereon. When the computer program is executed by a processor, the recommendation method for a delivery resource of an outdoor advertisement is implemented. The recommendation method includes: determining candidate delivery resources according to historical delivery information of a target client and a preset rule; obtaining a historical delivery record of all clients matched with attribute information of the target client, and obtaining a priority of each type of delivery resources in the historical delivery record of all clients; and determining a target delivery resource from the candidate delivery resources according to the priority of each type of delivery resources, and recommending the target delivery resource to the target client.

Additional aspects and advantages of embodiments of the present disclosure will be given in part in the following descriptions, and become apparent in part from the following descriptions, or be learned from the practice of the present disclosure.

### BRIEF DESCRIPTION OF THE DRAWINGS

These and other aspects and advantages of the present disclosure will become apparent and more readily appreciated from the following descriptions of embodiments made with reference to the drawings, in which:

FIG. 1 is a flow chart illustrating a recommendation method for a delivery resource of an outdoor advertisement provided in Embodiment 1 of the present disclosure;

FIG. 2 is a flow chart illustrating a recommendation method for a delivery resource of an outdoor advertisement provided in Embodiment 2 of the present disclosure;

FIG. 3 is a flow chart illustrating a recommendation method for a delivery resource of an outdoor advertisement provided in Embodiment 3 of the present disclosure;

FIG. 4 is a flow chart illustrating a recommendation method for a delivery resource of an outdoor advertisement provided in Embodiment 4 of the present disclosure;

FIG. 5 is a flow chart illustrating a recommendation method for a delivery resource of an outdoor advertisement provided in Embodiment 5 of the present disclosure;

FIG. 6 is a block diagram illustrating a recommendation apparatus for a delivery resource of an outdoor advertisement provided in Embodiment 1 of the present disclosure;

FIG. 7 is a block diagram illustrating a recommendation apparatus for a delivery resource of an outdoor advertisement provided in Embodiment 2 of the present disclosure;

FIG. 8 is a block diagram illustrating a recommendation apparatus for a delivery resource of an outdoor advertisement provided in Embodiment 3 of the present disclosure;

FIG. 9 is a block diagram illustrating a recommendation apparatus for a delivery resource of. an outdoor advertisement provided in Embodiment 4 of the present disclosure;

FIG. 10 is a block diagram illustrating a recommendation apparatus for a delivery resource of an outdoor advertisement provided in Embodiment 5 of the present disclosure; and

FIG. 11 is a block diagram illustrating a computer device provided in embodiments of the present disclosure.

### DETAILED DESCRIPTION

Description will be made in detail below to embodiments of the present disclosure. Examples of embodiments are illustrated in the accompanying drawings, in which, the same or similar numbers represent the same or similar elements or elements with the same or similar functions. Embodiments described below with reference to the accompanying drawings are exemplary, which are intended to explain the present disclosure and do not be understood a limitation of the present disclosure.

A recommendation method and a recommendation apparatus for a delivery resource of an outdoor advertisement, and a computer device provided in embodiments of the present disclosure will be described below with reference to the accompanying drawings.

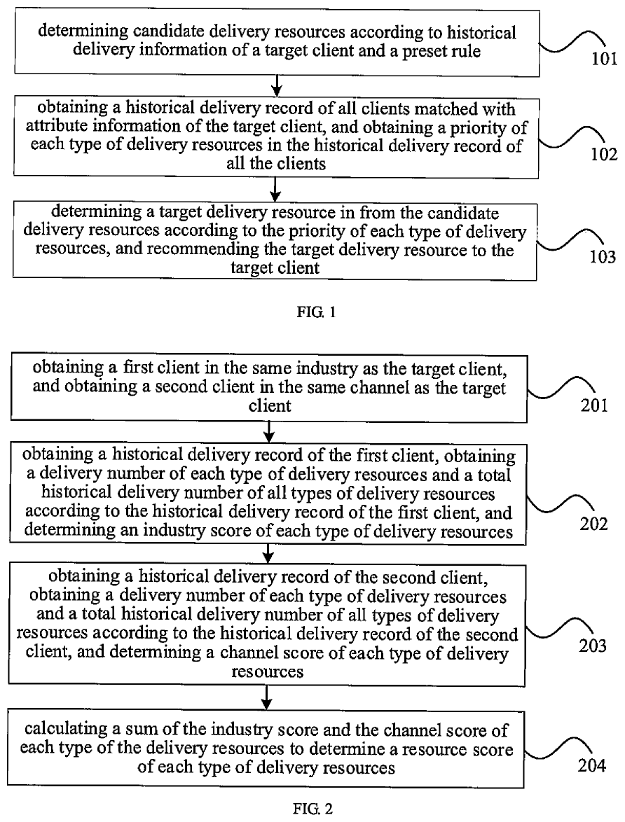

FIG. 1 is a flow chart illustrating a recommendation method for a delivery resource of an outdoor advertisement provided in Embodiment 1 of the present disclosure. The recommendation method may be applied to a purchase platform for the delivery resource. The purchase platform for the delivery resource may be represented in form of an application, or in form of a webpage. When there is a need for purchasing the delivery resource, a client only opens the installed application or inputs a website of the purchase platform for the delivery resource in a browser, and the purchase platform for the delivery resource may be entered. By applying the purchase platform for the delivery resource provided by the recommendation method for the delivery resource of the outdoor advertisement of the present disclosure, a delivery resource suitable to the client may be recommend to the client, implementing an automatic recommendation.

As illustrated in FIG. 1, the recommendation method for a delivery resource of an outdoor advertisement may include actions at following blocks.

At block 101, candidate delivery resources are determined according to historical delivery information of a target client and a preset rule.

The historical delivery information may include such as a historical delivery address, a historical delivery radius, a shop address of the client, a type of the historical delivery resource and a price. The historical delivery information of the client may be stored in a database corresponding to the purchase platform for the delivery resource after collected by an information collection personnel, and when the client purchases the delivery resource using the purchase platform for the delivery resource, the historical delivery information of the client is determined according to the delivery resource purchased by the client and stored in the database corresponding to the purchase platform for the delivery resource.

When the client enters the purchase platform for the delivery resource, the purchase platform for the delivery resource determines the client as the target client, and obtains the historical delivery information of the target client. For example, the purchase platform for the delivery resource may determine historical delivery information corresponding to a registration account number from the database as the historical delivery information of the target client according to the registration account number of the target client.

In this embodiment, candidate delivery resources matched with the historical delivery information are determined according to the historical delivery information of the target client and the preset rule after the historical delivery information of the target client is obtained. The preset rule may be set in advance in the purchase platform for the delivery resource, or set by the client based on the client's own advertisement delivery need.

As an example, the historical delivery information of the target client includes the shop address of the target client and a price of a historically purchased delivery resource. If a corresponding preset rule is that an address where the delivery resource locates is in the same area as the shop address and a difference between a price of the delivery resource and the price of the historically purchased delivery resource does not exceed a preset difference, when the candidate delivery resources are determined according to the historical delivery information and the preset rule, delivery resources in all delivery resources included in the area where the shop address of the target client locates are determined as the candidate delivery resources, in which, a difference between a price of each determined delivery resource and the price of the historically purchased delivery resource does not exceed the preset difference.

For example, it is assumed that the shop address of the target client is No. 33, Cuiwei Road, Haidian District, Beijing, the prices of the historically purchased delivery resources include 300 and 500, and the preset difference is ±50, the purchase platform for the delivery resource determines delivery resources of which the prices are among 250-350 and 450˜550 in all delivery resources in the Haidian District as the candidate delivery resources.

As an example, the historical delivery information of the target client includes the historical delivery address. When the corresponding preset rule is that the address where the delivery resource locates is in the same area as the historical delivery address, the delivery resources located at the historical delivery address are determined as the candidate delivery resources. For example, the historical delivery address is A shopping mall, delivery resources which are at the same street as A shopping mall locates are determined as the candidate delivery resources.

As an example, the historical delivery information of the target client includes the shop address of the target client. When the corresponding preset rule is that the address of the delivery resource is in the same city as the shop address, delivery resources included in the city where the shop address locates are determined as the candidate delivery resources; and when the corresponding preset rule is that the address of the delivery resource locates within a preset distance from the shop address, delivery resources within a preset range taking the shop address as a center may be determined as the candidate delivery resources. For example, delivery resources within 100 km around the shop address may be determined as the candidate delivery resources.

As an example, the historical delivery information of the target client includes the historical delivery address and the historical delivery radius. When the preset rule is that the address of the delivery resource is within a range of a preset length from the historical delivery address, and the preset length is the historical delivery radius, delivery resources in a circle area with a center of the shop address of the target client and a radius of the historical delivery radius are determined as the candidate delivery resources.

In a possible implementation of embodiments of the present disclosure, the historical delivery information of the target client includes the historical delivery address, the shop address of the target client, and the historical delivery radius, and determining the candidate delivery resources according to the historical delivery information of the target client and the preset rule includes: determining delivery resources in an area where the historical delivery address locates as the candidate delivery resources; and/or, determining delivery resources in the circle area with the center of the shop address of the target client and the radius of the historical delivery radius as the candidate delivery resources.

For example, when the historical delivery addresses are distributed in different positions of Haidian District, Beijing, delivery resources within Haidian District, Beijing may be determined as the candidate delivery resources.

At block 102, a historical delivery record of all clients matched with attribute information of the target client is obtained, and a priority of each type of delivery resources in the historical delivery record of all clients is obtained.

The attribute information may be, for example, a name of a business operated by the client, an industry and a channel to which the business operated by the client belongs, a type of an operated product, a business license number and the like. The channel refers to operating online or offline, i.e., the client runs the business via an online channel or an offline channel. The attribute information of the client may be inputted by the client himself/herself For example, when the client uses the purchase platform for the delivery resource firstly, the purchase platform for the delivery resource provides an input interface for the client to input the attribution information of the client itself

In this embodiment, the attribute information of the target client may be obtained by the purchase platform for the delivery resource automatically when the target client enters the purchase platform for the delivery resource. For example, the purchase platform for the delivery resource may obtain attribute information corresponding to the registration account number as the attribute information of the target client according to the registration account number of the target client.

There are multiple delivery channels for the delivery resource of the outdoor advertisement, such as an access control screen of a residence, an advertisement column at a bus station, billboards at the two sides of a road, an electronic advertisement panel outside a shopping mall, and the like. There are certain similarities among the delivery channels selected by different clients who have a competitive relationship. Therefore, in this embodiment, a client similar to the target client is determined according to the attribution information of the target client, and the priority of each type of delivery resources is determined according to a historical delivery record of the similar client.

As an example, the attribute information of the target client includes the product type operated by the target client. The purchase platform for the delivery resource may filter all clients that operate the same product type as the target client from the stored clients and obtain historical delivery records of the all clients, count a delivery number of each type of delivery resources delivered historically by the all clients and a total historical delivery number of all types of delivery resources according to the historical delivery record of the all clients. A proportion of the delivery number of each type of delivery resources served in the total historical delivery number (a ratio of delivery number of each type of delivery resources to the total number) is calculated according to the delivery number of each type of delivery resources and the total historical delivery number, and the priority of each type of delivery resources is determined according to the proportion. The higher the proportion, the higher the priority. For example, if the historical delivery number of the electronic advertisement panel in the shopping mall is m0, the historical delivery number of the access control screen of the residence is m1, and the total historical delivery number is n1, in which, m0 is smaller than m1, the proportion of the historical delivery number of the electronic advertisement panel in the shopping mall served in the total historical delivery number is m0/n1, the proportion of the historical delivery number of the access control screen of the residence served in the total historical delivery number is m1/n1, and the priority of the access control screen of the residence is greater than the priority of the electronic advertisement panel in the shopping mall.

At block 103, a target delivery resource is determined from the candidate delivery resources according to the priority of each type of delivery resources, and the target delivery resource is recommended to the target client.

In this embodiment, after the priority of each type of delivery resources is determined, the target delivery resource is determined from the candidate delivery resources according to the priority of each type of delivery resources, and the determined target delivery resource is recommended to the target client.

As an example, a preset number of a certain type of candidate resources with the high priority are selected from the candidate resources as target candidate resources. For example, the priority of the access control screen of the residence is the greatest, 10 access control screens of the residences are selected from the candidate delivery resources as the target delivery resource.

As an example, a preset number of different types of delivery resources with different priorities are selected from the candidate delivery resources as the target candidate delivery resources according to the priority of each type of delivery resources. For example, the number of the target delivery resources is 10, top-5 delivery resources with the highest priority, 3 delivery resources with the second highest priority and 2 delivery resources with the third highest priority may be selected from the candidate delivery resources as the target delivery resources, to improve the diversity of the target delivery resources.

With the recommendation method for the delivery resource of the outdoor advertisement of the embodiments, the candidate delivery resources are determined according to the historical delivery information of the target client and the preset rule, the historical delivery record of all clients matched with the attribute information of the target client is obtained, and the priority of each type of delivery resources in the historical delivery record of all clients is obtained, and then the target delivery resource is determined from the candidate delivery resources according to the priority of each type of delivery resources, and is recommended to the target client. Therefore, an automatic recommendation for the delivery resource of the outdoor advertisement is implemented, a cumbersome procedure that a client performs search query for the delivery resources for a plurality of times is avoided, a query time is saved, and the purchase efficiency and a delivery efficiency of the delivery resource are improved. The target delivery resource is determined and recommended to the target client according to the attribute information and the historical delivery information of the target client, implementing a personalized recommendation for the delivery resource, improving an accuracy of the recommendation and improving advertisement delivery experience of the client.

In a possible implementation of embodiments of the present disclosure, the attribute information of the target client includes the industry and the channel to which business operated by the target client belongs, and the priority of each type of delivery resources is a resource score of each type of delivery resources. A detailed implementation procedure for determining the priority of each type of delivery resources in the above embodiments will be described in detail below with reference to FIG. 2.

FIG. 2 is a flow chart illustrating a recommendation method for a delivery resource of an outdoor advertisement provided in Embodiment 2 of the present disclosure. As illustrated in FIG. 2, on the basis of the embodiment illustrated in FIG. 2, actions at the block 102 may include following actions at following blocks.

At block 201, a first client in the same industry as the target client is obtained, and a second client in the same channel as the target client is obtained.

For example, if the industry of the target client is the food industry, and the channel is the operation offline, all clients in the food industry are filtered as the first client and all clients operated offline are filtered as the second client from the clients recorded in the purchase platform for the delivery resource.

At block 202, a historical delivery record of the first client is obtained, a delivery number of each type of delivery resources and a total historical delivery number of all types of delivery resources are obtained according to the historical delivery record of the first client, and an industry score of each type of delivery resources is determined.

In this embodiment, after the first client is determined, the purchase platform for the delivery resource may obtain the historical delivery record of the first client from the database, count the delivery number of each type of delivery resources and the total historical delivery number of all types of delivery resources according to the historical delivery record, and calculate the industry score of each type of delivery resources for each type of delivery resources according to the delivery number of the type of delivery resource and the total historical delivery number.

For example, the type of the historical delivery resources of the first client includes an access control screen of a residence and an advertisement column of a bus station. If the delivery number of the access control screens of the residence is m2, the delivery number of the advertisement columns of the bus station is m3, and the total historical delivery number is n2 (n2=m2+m3), an industry score of the access control screen of the residence is m2/n2, and an industry score of advertisement column of the bus station is m3/n2.

At block 203, a historical delivery record of the second client is obtained, a delivery number of each type of delivery resources and a total historical delivery number of all types of delivery resources are obtained according to the historical delivery record of the second client, and a channel score of each type of delivery resources is determined.

In this embodiment, after the second client is determined, the purchase platform for the delivery resource may obtain the historical delivery record of the second client from the database, count the delivery number of each type of delivery resources and the total historical delivery number of all types of delivery resources according to the historical delivery record, and calculate the channel score of each type of delivery resources for each type of delivery resources according to the delivery number of the type of delivery resource and the total historical delivery number.

For example, the type of the historical delivery resources of the second client includes an access control screen of a residence and an advertisement column of a bus station. If the delivery number of the access control screens of the residence is m4, the delivery number of the advertisement columns of the bus station is m5, and the total historical delivery number is n3 (n3=m4+m5), a channel score of the access control screen of the residence is m4/n3, and a channel score of advertisement column of the bus station is m5/n3.

At block 204, a sum of the industry score and the channel score of each type of the delivery resources is calculated to determine a resource score of each type of delivery resources.

As an example, for each type of delivery resources, the industry score and the channel score of the type of delivery resource may be summarized to obtain the resource score of the type of delivery resource.

As an example, for each type of delivery resources, corresponding weights may be assigned for the industry score and the channel score in advance, thus calculating the resource score of the type of delivery resource in a weighted summation way.

For example, for the access control screen of the residence, if a weight assigned in advance corresponding to the industry score is 0.6, and a weight assigned in advance corresponding to the channel score is 0.4, the resource score of the access control screen of the residence is 0.6*the industry score +0.4*the channel score.

With the recommendation method for the delivery resource of the outdoor advertisement of the embodiment, when the attribute information of the target client includes the industry and the channel to which business operated by the target client belongs, and the priority of each type of delivery resources is the resource score of each type of delivery resources, by obtaining the first client in the same industry as the target client, and obtaining the second client in the same channel as the target client; obtaining the historical delivery record of the first client to determine the industry score of each type of delivery resources; and obtaining the historical delivery record of the second client to determine the channel score of each type of delivery resources, the sum of the industry score of each type of the delivery resource and the channel score of each type of the delivery resources are calculated to determine the resource score of each type of delivery resources, thus providing a basis for determining the target delivery resource, helping to recommend the delivery resource satisfying the need for the target client, and providing a basis for improving the recommendation accuracy.

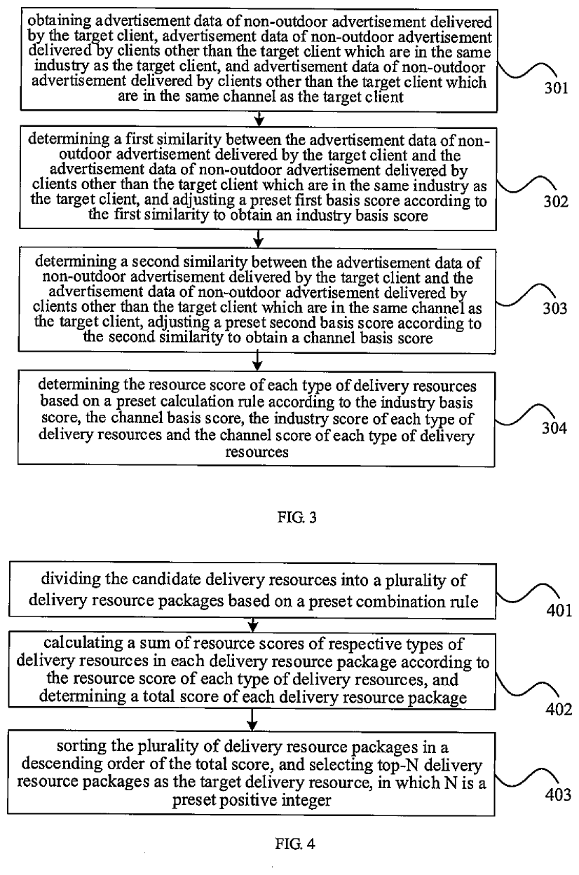

In order to further improve the accuracy and the rationality for calculating the resource score of each type of delivery resources and to improve the recommendation accuracy of the delivery resource, in a possible implementation of embodiments of the present disclosure, the resource score of each type of delivery resources may be determined in combination with advertisement data delivered by the target client and clients other than the target client in other advertisement delivery channel (such as the Baidu application). With reference to FIG. 3 below, a detailed implementation procedure for determining the resource score of each type of delivery resources will be described in detail in combination with the advertisement data delivered by the target client and the clients other than the target client in other advertisement delivery channel, the industry score of each type of delivery resources, and the channel score of each type of delivery resources.

FIG. 3 is a flow chart illustrating a recommendation method for a delivery resource of an outdoor advertisement provided in Embodiment 3 of the present disclosure. As illustrated in FIG. 3, on the basis of the embodiment illustrated in FIG. 2, before the actions at block 204, the method further includes actions at following blocks.

At block 301, advertisement data of non-outdoor advertisement delivered by the target client, advertisement data of non-outdoor advertisement delivered by clients other than the target client which are in the same industry as the target client, and advertisement data of non-outdoor advertisement delivered by clients other than the target client which are in the same channel as the target client are obtained.

The non-outdoor advertisement may include such as advertisement displayed by the Baidu application, advertisement broadcasted in a video player (including a television and respective video player) and the like.

The advertisement data of non-outdoor advertisement may be collected by information collection personnel, and the collected advertisement data of non-outdoor advertisement of each client is stored in a server, or stored in the database corresponding to the purchase platform for the delivery resource. The information collection personnel may collect the advertisement data of non-outdoor advertisement of each client at fixed period, to update the advertisement data of non-outdoor advertisement delivered by each client and stored in the server or in the database.

In this embodiment, after the attribute information of the target client is obtained, the purchase platform for the delivery resource may determine the clients other than the target client which are in the same industry and the clients other than the target client which are in the same channel according to the attribute information, and obtain the advertisement data of non-outdoor advertisement delivered by each client, the advertisement data of non-outdoor advertisement delivered by the clients other than the target client which are in the same industry, and the advertisement data of non-outdoor advertisement delivered by the clients other than the target client which are in the same channel.

As an example, when the advertisement data of non-outdoor advertisement delivered by each client is stored in the server or stored in the database, a corresponding relationship between a business license number and the advertisement data may be stored, such that the advertisement data may be obtained according to the business license number when the advertisement data delivered by the target client, the clients other than the target client which are in the same industry and the clients other than the target client which are in the same channel is obtained.

At block 302, a first similarity between the advertisement data of non-outdoor advertisement delivered by the target client and the advertisement data of non-outdoor advertisement delivered by the clients other than the target client which are in the same industry as the target client is determined, and a preset first basis score is adjusted according to the first similarity to obtain an industry basis score.

The first basis score may be set in advance. For example, the first basis score is set to 50. An adjustment amplitude for adjusting the first basis score may be set in advance according to the first similarity. For example, when the first similarity is set to 0, the corresponding adjustment amplitude is 0, when the first similarity is set to 0 (not including 0) ˜10% (not including 10%), the corresponding adjustment amplitude is +5, when the first similarity is set to 10% (including 10%) ˜20% (not including 20%), the corresponding adjustment amplitude is +10, . . . , when the first similarity is set to 80% (including 80%) ˜90% (not including 90%), the corresponding adjustment amplitude is +45, and when the first similarity is set to 90% (including 90%) ˜100% (including 90%), the corresponding adjustment amplitude is +50.

When comparing the advertisement data of the non-outdoor advertisement delivered by the target client with the advertisement data of the non-outdoor advertisement delivered by the clients other than the target client which are in the same industry as the target client to determine the first similarity, channels, content and the like of the advertisement data of non-outdoor advertisement delivered by the target client and channels, content and the like of the advertisement data of non-outdoor advertisement delivered by the clients other than the target client which are in the same industry as the target client may be compared. For example, if the channels of the advertisement data of the non-outdoor advertisement delivered by the target client include television advertisement and webpage advertisement, and the channels of the non-outdoor advertisement delivered by the clients other than the target client which are in the same industry include the television advertisement and subscription account advertisement (displaying a product in form of characters, images and the like in the subscription account), it is considered that the first similarity is 50%, such that the industry basis score may be determined as 80 according to the preset first basis score and the adjustment amplitude.

When the first similarity is calculated based on the delivered advertisement content, segmentation may be performed on the advertisement content by employing word segmentation technology, to obtain a plurality of segmented words, the segmented words are converted into word vectors by word2vec, and the similarity between the advertisement content is calculated by utilizing the euclidean distance and the cosine similarity. Since there may be a plurality of clients other than the target client which are in the same industry as the target client, a similarity between the advertisement content of the target client and the advertisement content of each client other than the target client which are in the same industry as the target client may be calculated, and a maximum similarity may be selected as the first similarity.

At block 303, a second similarity between the advertisement data of non-outdoor advertisement delivered by the target client and the advertisement data of non-outdoor advertisement delivered by the clients other than the target client which are in the same channel as the target client is determined, a preset second basis score according to the second similarity is adjusted to obtain a channel basis score.

In this embodiment, the procedure for determining the channel basis score may refer to the procedure for determining the industry basis score at block 302, which has the similar principle with the actions at block 302 and is not elaborated herein.

It should be noted that, embodiments of the present disclosure do not limit the execution sequence for actions at blocks 201-203 and blocks 301-303, both blocks 201-203 and blocks 301-303 may be executed simultaneously and may be executed successively.

Further, as illustrated in FIG. 3, the actions at block 204 include actions at the following block.

At block 304, the resource score of each type of delivery resources is determined based on a preset calculation rule according to the industry basis score, the channel basis score, the industry score of each type of delivery resources and the channel score of each type of delivery resources.

The calculation rule may be set in advance. For example, the calculation rule may be represented by Equation (1).

In detail, the resource score of each type of delivery resources may be calculated by

$${a}_{1} * tan ( \frac{π}{2} * p ) + {a}_{2} * tan ( \frac{π}{2} * q ) \qquad ( 1 )$$

where a₁ represents the industry basis score, a₂ represents the channel basis score, p represents the industry score, and q represents the channel score.

For each type of delivery resources, by utilizing the above Equation (1), the resource score of each type of delivery resources may be determined.

With the recommendation method for the delivery resource of the outdoor advertisement of the embodiment, the advertisement data of non-outdoor advertisement delivered by the target client, the advertisement data of non-outdoor advertisement delivered by the clients other than the target client which are in the same industry as the target client and the advertisement data of the non-outdoor advertisement delivered by the clients other than the target client which are in the same channel as the target client are obtained; the first similarity between the advertisement data of non-outdoor advertisement delivered by the target client and the advertisement data of non-outdoor advertisement delivered by the clients other than the target client which are in the same industry as the target client, and the second similarity between the advertisement data of non-outdoor advertisement delivered by the target client and the advertisement data of non-outdoor advertisement delivered by the clients other than the target client which are in the same channel as the target client are determined, the preset first basis score is adjusted according to the first similarity to obtain the industry basis score, the preset second basis score is adjusted according to the second similarity to obtain the channel basis score; and then the resource score of each type of delivery resources is determined based on the preset calculation rule according to the industry basis score, the channel basis score, the industry score of each type of delivery resources and the channel score of each type of delivery resources, thus improving the accuracy and the rationality for calculating the resource score of each type of delivery resources, and helping to improve the recommendation accuracy for the delivery resource.

The target delivery resource in embodiment of the present disclosure may be at least one independent delivery resource, and may also be at least one delivery resource package. The delivery resource package includes at least one delivery resource. The detailed implementation procedure for determining the target delivery resource will be described below with reference to FIG. 4 when the target delivery resource is the delivery resource package.

FIG. 4 is a flow chart illustrating a recommendation method for a delivery resource of an outdoor advertisement provided in Embodiment 4 of the present disclosure. As illustrated in FIG. 4, on the basis of the embodiment illustrated in FIG. 2 or FIG. 3, the actions block 103 may include actions at following blocks.

At block 401, the candidate delivery resources are divided into a plurality of delivery resource packages based on a preset combination rule.

The preset combination rule may be that each delivery resource package includes at least one delivery resource of each type of delivery resources. Or, the preset combination rule may be that each delivery resource package includes 50 delivery resources, and a total price of delivery resources in each delivery resource package is 80%˜120% of a median of a historical delivery money amount of the target client. Or, the preset combination rule may be that each delivery resource package includes a preset number of delivery resources, in which, 60% of the preset number of the delivery resources are delivery resources with a money amount floating scope being 80%˜120% of the median of the historical delivery money amount, 20% of the preset number of the delivery resources are delivery resources with a high resource score in one day, and 20% of the preset number of the delivery resources are delivery resources with a high resource score in a plurality of days. The number of delivery resources included in each delivery resource package may be different.

For example, the preset combination rule being that each delivery resource includes each type of 5 delivery resources is taken as an example, each type of 5 delivery resources may be combined into one delivery resource package. When the combination is performed, different types of delivery resources which are close to each other may be combined into one delivery resource package with reference to positions of the delivery resources.

Further, in order to ensure that the target delivery resource which is recommended for the target client is usable, when grouping the candidate delivery resources, it may be determined whether the candidate delivery resources are usable firstly, and then the usable candidate delivery resources are divided into the plurality of delivery resource packages.

At block 402, a sum of resource scores of respective types of delivery resources in each delivery resource package is calculated according to the resource score of each type of delivery resources, and total scores of respective delivery resource packages are determined.

For each delivery resource package, the type of the delivery resources included in the delivery resource package may be determined firstly, and then the total score of each delivery resource package may be determined in a summation way according to the resource score of each type of delivery resources.

At block 403, the plurality of delivery resource packages are sorted in a descending order of the total scores, and top-N delivery resource packages are selected as the target delivery resource, in which N is a preset positive integer.

N may be set in advance. For example, N may be set to 10.

In this embodiment, after the total score of each delivery resource package is determined, the plurality of delivery resource packages may be sorted in the descending order of the total scores, a preset number of delivery resource packages sorted in the front of the total scores are selected as the target delivery resource, and the target delivery resource is recommended to the target client. Other delivery resource packages which are not selected may be used for a following recommendation, to avoid that the procedure for determining the target delivery resource is executed again in the following recommendation. In this way, the preset number of delivery resource packages only need to be selected as the target delivery resource, thus reducing an operation burden of the purchase platform for the delivery resource.

With the recommendation method for the delivery resource of the outdoor advertisement of the embodiment, the candidate delivery resources are divided into the plurality of delivery resource packages based on the preset combination rule; the sum of resource scores of respective types of delivery resources in each delivery resource package is calculated according to the resource score of each type of delivery resources, and the total score of each delivery resource package is determined; and then the plurality of delivery resource packages are sorted in the descending order of the total scores, and the top-N delivery resource packages are selected as the target delivery resource, thus improving the diversity of the target delivery resource, helping to improve a probability of the target delivery resource being purchased by the target client, and improving a success rate of the recommendation.

In order to recommend the delivery resource in accordance to the need of the target client for the target client, and further to improve the accuracy of the recommendation, in a possible implementation of embodiments of the present disclosure, a delivery preference of the target client may be determined according to the delivery resource purchased by the target client. Therefore, as illustrated in FIG. 5, on the basis of the above embodiments, after the actions at block 103, the method further includes actions at following blocks.

At block 501, purchase information of the target delivery resource delivered by the target client is obtained.

The purchase platform for the delivery resource recommends the determined target delivery resource to the target client, and the target delivery resource is displayed in the display interface of the device which the target client is using for selection of the client. When the target client purchases at least one target delivery resource from the recommended target delivery resources, the purchase platform for the delivery resource obtains purchase information of the target delivery resource purchased by the target client. The purchase information includes a type, a price, an address and the like of the target delivery resource purchased by the target client.

At block 502, a delivery preference is determined and recorded based on the purchase information.

In this embodiment, the purchase platform for the delivery resource may determine the delivery preference of the target client according to the obtained purchase information. For example, if the target client purchases a target delivery resource with a lower price, it may be determined that the target client is inclined to delivery resources with a low price, and the purchase platform for the delivery resource records the delivery preference of the target client, and will preferentially recommend the delivery resources with a low price for the target client in the following recommendation.

With the recommendation method for the delivery resource of the outdoor advertisement of the embodiment, the purchase information of the target delivery resource delivered by the target client is obtained; and the delivery preference is determined and recorded based on the purchase information, thus helping to improve pertinence of the delivery resource, and improving a success rate of the purchase.

To implement the above embodiments, the present disclosure further provides a recommendation apparatus for a delivery resource of the outdoor advertisement.

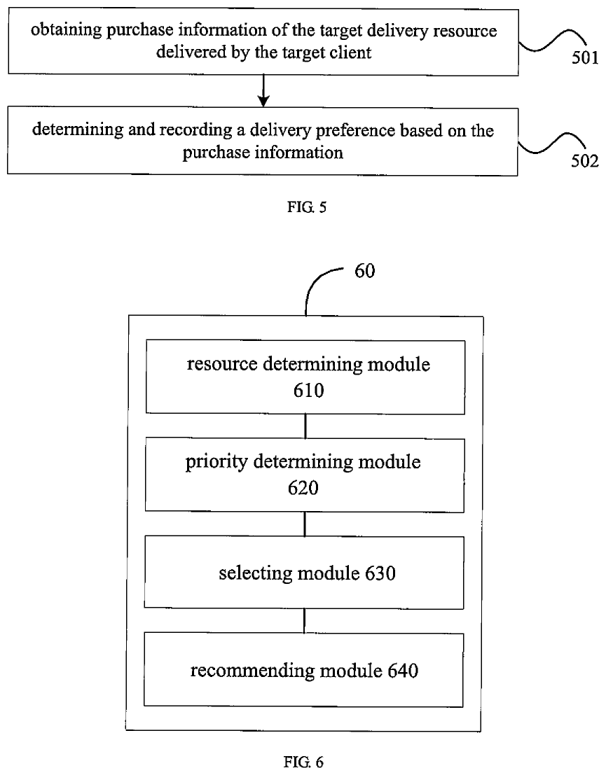

FIG. 6 is a block diagram illustrating a recommendation apparatus for a delivery resource of an outdoor advertisement provided in Embodiment 1 of the present disclosure.

As illustrate in FIG. 6, the recommendation apparatus 60 for the delivery resource of the outdoor advertisement may include: a resource determining module 610, a priority determining module 620, a selecting module 630, and a recommending module 640.

The resource determining module 610 is configured to determine candidate delivery resources according to historical delivery information of a target client and a preset rule.

In a possible implementation of embodiments of the present disclosure, the historical delivery information of the target client includes a historical delivery address, a shop address of the target client, and a historical delivery radius, and the resource determining module 610 is configured to: determine delivery resources in an area where the historical delivery address locates as the candidate delivery resources; and/or, determine delivery resources in a circle area with a center of the shop address of the target client and a radius of the historical delivery radius as the candidate delivery resources.

The priority determining module 620 is configured to obtain a historical delivery record of all clients matched with attribute information of the target client, and to obtain a priority of each type of delivery resources in the historical delivery record of all clients.

The selecting module 630 is configured to determine a target delivery resource from the candidate delivery resources according to the priority of each type of delivery resources.

The recommending module 640 is configured to recommend the target delivery resource to the target client.

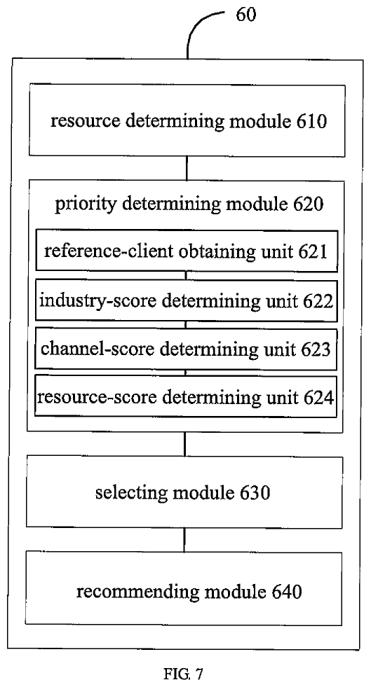

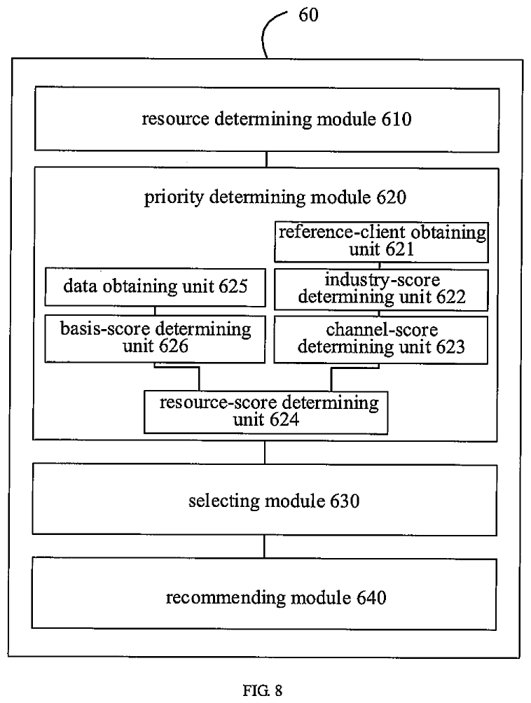

In a possible implementation of embodiments of the present disclosure, the attribute information of the target client includes an industry and a channel to which business operated by the target client belongs, and the priority of each type of delivery resources is a resource score of each type of delivery resources. As illustrated in FIG. 7, on the basis of the embodiment illustrated in FIG. 6, the priority determining module 620 includes: a reference-client obtaining unit 621, an industry-score determining unit 622, a channel-score determining unit 623 and a resource-score determining unit 624.

The reference-client obtaining unit 621 is configured to obtain a first client in the same industry as the target client, and to obtain a second client in the same channel as the target client.

The industry-score determining unit 622 is configured to obtain a historical delivery record of the first client, to obtain a delivery number of each type of delivery resources and a total historical delivery number of all types of delivery resources according to the historical delivery record of the first client, and to determine an industry score of each type of delivery resources.

The channel-score determining unit 623 is configured to obtain a historical delivery record of the second client, to obtain a delivery number of each type of delivery resources and a total historical delivery number of all types of delivery resources according to the historical delivery record of the second client, and to determine a channel score of each type of delivery resources.

The resource-score determining unit 624 is configured to calculate a sum of the industry score and the channel score of each type of the delivery resources to determine a resource score of each type of delivery resources.

With the recommendation apparatus for the delivery resource of the outdoor advertisement of the embodiment, a basis is provided for determining the target delivery resource, it helps to recommend the delivery resource satisfying the need for the target client, and a basis for improving the recommendation accuracy is provided.

In a possible implementation of embodiments of the present disclosure, as illustrated in FIG. 8, on the basis of the embodiment illustrated in FIG. 7, the priority determining module 620 further includes: a data obtaining unit 625 and a basis-score determining unit 626.

The data obtaining unit 625 is configured to obtain advertisement data of non-outdoor advertisement delivered by the target client, advertisement data of non-outdoor advertisement delivered by clients other than the target client which are in the same industry as the target client, and advertisement data of non-outdoor advertisement delivered by clients other than the target client which are in the same channel as the target client.

The basis-score determining unit 626 is configured to determine a first similarity between the advertisement data of non-outdoor advertisement delivered by the target client and the advertisement data of non-outdoor advertisement delivered by the clients other than the target client which are in the same industry as the target client, to adjust a preset first basis score according to the first similarity to obtain an industry basis score; and to determine a second similarity between the advertisement data of non-outdoor advertisement delivered by the target client and the advertisement data of non-outdoor advertisement delivered by the clients other than the target client which are in the same channel as the target client, and to adjust a preset second basis score according to the second similarity to obtain a channel basis score.

In this embodiment, the resource-score determining unit 624 is further configured to determine the resource score of each type of delivery resources based on a preset calculation rule according to the industry basis score, the channel basis score, the industry score of each type of delivery resources and the channel score of each type of delivery resources.

With the recommendation apparatus for the delivery resource of the outdoor advertisement of the embodiment, the accuracy and the rationality for calculating the resource score of each type of delivery resources are improved, and it helps to improve the recommendation accuracy for the delivery resource.

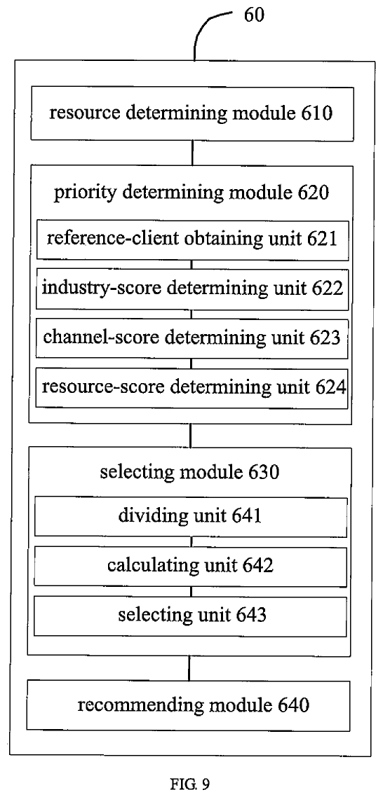

In a possible implementation of embodiments of the present disclosure, as illustrated in FIG. 9, on the basis of the embodiment illustrated in FIG. 7, the selecting module 630 includes: a dividing unit 631, a calculating unit 632 and a selecting unit 633.

The dividing unit 631 is configured to divide the candidate delivery resources into obtain a plurality of delivery resource packages based on a preset combination rule.

The calculating unit 632 is configured to calculate a sum of resource scores of respective types of delivery resources in each delivery resource package according to the resource score of each type of delivery resources, and to determine total scores of respective delivery resource packages.

The selecting unit 633 is configured to sort the plurality of delivery resource packages in a descending order of the total scores, and to select top-N delivery resource packages as the target delivery resource, in which N is a preset positive integer.

With the recommendation apparatus for the delivery resource of the outdoor advertisement of the embodiment, the diversity of the target delivery resource is improved, it helps to improve a probability of the target delivery resource being purchased by the target client, and a success rate of the recommendation is improved.

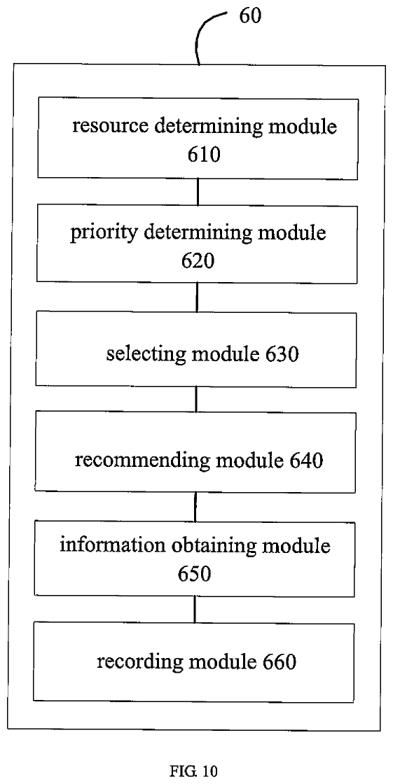

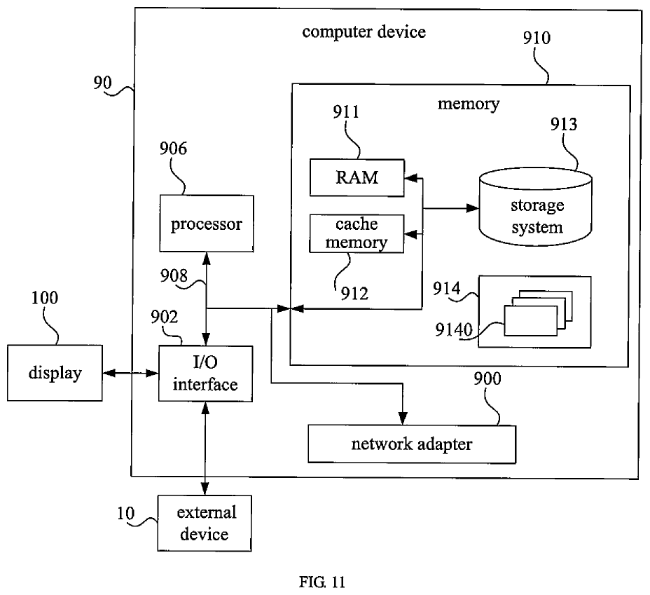

In a possible implementation of embodiments of the present disclosure, as illustrated in FIG. 10, on the basis of the embodiment illustrated in FIG. 6, the recommendation apparatus 60 for the delivery resource of the outdoor advertisement further includes: an information obtaining module 650 and a recording module 660.

The information obtaining module 650 is configured to obtain purchase information of the target delivery resource delivered by the target client.

The recording module 660 is configured to determine and to record a delivery preference based on the purchase information.

With the recommendation apparatus for the delivery resource of the outdoor advertisement of the embodiment, pertinence for the delivery resource is improved and a success rate of the purchase is improved.

It should be noted that, the above description for the recommendation method for the delivery resource of the outdoor advertisement may be applied to the recommendation apparatus for the delivery resource of the outdoor advertisement of the embodiment, and the implementation principle is similar to the above description, which is not elaborated herein.

With the recommendation apparatus for the delivery resource of the outdoor advertisement of the embodiments of the present disclosure, the candidate delivery resources are determined according to the historical delivery information of the target client and the preset rule, the historical delivery record of all clients matched with the attribute information of the target client is obtained, and the priority of each type of delivery resources in the historical delivery record of all clients is obtained, and then the target delivery resource is determined from the candidate delivery resources according to the priority of each type of delivery resources, and is recommended to the target client. Therefore, an automatic recommendation for the delivery resource of the outdoor advertisement is implemented, a cumbersome procedure that a client performs search query for the delivery resources for a plurality of times is avoided, a query time is saved, and the purchase efficiency and a delivery efficiency of the delivery resource are improved. The target delivery resource is determined and recommended to the target client according to the attribute information and the historical delivery information of the target client, implementing a personalized recommendation for the delivery resource, improving an accuracy of the recommendation and improving advertisement delivery experience of the client.

To implement the above embodiments, the present disclosure further provides a computer device. The computer device includes: a processor and a memory The processor is configured to operate a program corresponding to executable program codes by reading the executable program codes stored in the memory, and to implement the recommendation method for a delivery resource of an outdoor advertisement according to the above embodiments.

FIG. 11 is a block diagram illustrating a computer device provided in embodiments of the present disclosure, and illustrating an exemplary computer device 90 capable to implement implementations of the present disclosure. The computer device 90 illustrated in FIG. 10 is only an example, which may not bring any limitation to functions and scope of embodiments of the present disclosure.

As illustrated in FIG. 11, the computer device 90 is embodied in the form of a general-purpose computer device. Components of the computer device 90 may include but not limited to: one or more processors or processing units 906, a system memory 910, and a bus 908 connecting different system components (including the system memory 910 and the processing unit 906).

The bus 908 represents one or more of several bus structures, including a storage bus or a storage controller, a peripheral bus, an accelerated graphics port and a processor or a local bus with any bus structure in the plurality of bus structures. For example, these architectures include but not limited to an industry standard architecture (ISA) bus, a micro channel architecture (MAC) bus, an enhanced ISA bus, a video electronics standards association (VESA) local bus and a peripheral component interconnection (PCI) bus.

The computer device 90 typically includes various computer system readable mediums. These mediums may be any usable medium that may be accessed by the computer device 90, including volatile and non-volatile mediums, removable and non-removable mediums.

The system memory 910 may include computer system readable mediums in the form of volatile medium, such as a random access memory (RAM) 911 and/or a cache memory 912. The computer device 90 may further include other removable/non-removable, volatile/non-volatile computer system storage mediums. Only as an example, the storage system 913 may be configured to read from and write to non-removable, non-volatile magnetic mediums (not illustrated in FIG. 11, which is usually called “a hard disk driver”). Although not illustrated in FIG. 11, a magnetic disk driver configured to read from and write to the removable non-volatile magnetic disc (such as “a diskette”), and an optical disc driver configured to read from and write to a removable non-volatile optical disc (such as a CD-ROM, a DVD-ROM or other optical mediums) may be provided. Under these circumstances, each driver may be connected with the bus 908 by one or more data medium interfaces. The system memory 910 may include at least one program product. The program product has a set of program modules (such as, at least one program module), and these program modules are configured to execute functions of respective embodiments of the present disclosure.

The computer readable signal medium may include a data signal transmitted in the baseband or as part of a carrier, in which computer-readable program codes are carried. The transmitted data signal may employ a plurality of forms, including but not limited to an electromagnetic signal, a light signal or any suitable combination thereof. The computer-readable signal medium may further be any computer readable medium other than the computer-readable storage medium. The computer readable medium may send, propagate or transmit programs configured to be used by or in combination with an instruction execution system, apparatus or device.

The program codes included in the computer readable medium may be transmitted by any appropriate medium, including but not limited to wireless, electric wire, optical cable, RF (Radio Frequency), or any suitable combination of the foregoing.

The computer program codes for executing operations of the present disclosure may be programmed using one or more programming languages or the combination thereof. The programming languages include object-oriented programming languages, such as Java, Smalltalk, C++, and further include conventional procedural programming languages, such as the C programming language or similar programming languages. The program codes may be executed entirely on a user computer, partly on the user computer, as a stand-alone software package, partly on the user computer and partly on a remote computer, or entirely on the remote computer or server.

A program/utility tool 914, having a set (at least one) of program modules 9140, may be stored in the system memory 910. Such program modules 9140 include but not limited to an operating system, one or more application programs, other program modules, and program data. Each or any combination of these examples may include an implementation of a networking environment. The program module 9140 usually executes functions and/or methods described in embodiments of the present disclosure.

The electronic device 90 may communicate with one or more external devices 10 (such as a keyboard, a pointing device, and a display 100), may further communicate with one or more devices enabling a user to interact with the computer device 90, and/or may communicate with any device (such as a network card, and a modem) enabling the computer device 90 to communicate with one or more other computing devices. Such communication may occur via an Input/Output (I/O) interface 902. Moreover, the computer device 90 may further communicate with one or more networks (such as local area network (LAN), wide area network (WAN) and/or public network, such as Internet) via a network adapter 900. As illustrated in FIG. 11, the network adapter 900 communicates with other modules of the computer device 90 via the bus 908. It should be understood that, although not illustrated in FIG. 11, other hardware and/or software modules may be used in combination with the computer device 90, including but not limited to: microcode, device drivers, redundant processing units, external disk drive arrays, RAID (redundant array of independent disks) systems, tape drives, and data backup storage systems, etc.

The processor 906, by operating programs stored in the system memory 910, executes various function applications and data processing, for example implements the recommendation method for the delivery resource of the outdoor advertisement provided in above embodiments.

In order to implement the above embodiment, the present disclosure further provides a computer program product. When instructions in the computer program product are executed by a processor, the recommendation method for a delivery resource of an outdoor advertisement according to the above embodiments is implemented.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, without a contradiction, the different embodiments or examples and the features of the different embodiments or examples can be combined by those skilled in the art in the specification.

In addition, terms such as “first” and “second” are used herein for purposes of description and are not intended to indicate or imply relative importance or implicitly indicate the number of indicated technical features. Furthermore, the feature defined with “first” and “second” may include one or more this feature distinctly or implicitly. In the description of the present disclosure, “a plurality of” means at least two, such as two, three, unless specified otherwise.

Any procedure or method described in the flow charts or described in any other way herein may be understood include one or more modules, portions or parts for executing instruction codes that implement steps of a custom logic function or procedure. And preferable embodiments of the present disclosure include other implementation, in which the order of execution is different from that which is depicted or discussed, including executing functions in a substantially simultaneous manner or in an opposite order according to the related functions, which may be understood by the skilled in the art of embodiments of the present disclosure.

The logic and/or step described in other manners herein or shown in the flow chart, for example, a particular sequence table of executable instructions for realizing the logical function, may be specifically achieved in any computer readable medium to be used by the instruction execution system, device or equipment (such as a system based on computers, a system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

The skilled in the art may understand that implementing all or a part of steps carried by the method of the above embodiments may be completed by a program indicating the related hardware. All the program may be stored in a computer readable storage medium. The program includes one of the embodiments of the method or the combination thereof when being executed.

In addition, respective function units in respective embodiments of the present disclosure can be integrated in one processing unit, or respective unit can also exist physically alone, or two or more units may be integrated in one unit. The foregoing integrated unit may be implemented either in hardware or software functional units. If the integrated unit is implemented as a software functional unit and is sold or used as a stand-alone product, it may be stored in a computer readable storage medium.

The above mentioned storage medium may be a ROM, a disk or a disc. Although embodiments of the present disclosure have been shown and described above, it should be understood that, the above embodiments are exemplary, and cannot be understood to limit the present disclosure. Those skilled in the art can make changes, alternatives, and modifications in the embodiments within scope of the present disclosure.

What is claimed is:

1. A recommendation method for a delivery resource of an outdoor advertisement, comprising:
determining candidate delivery resources according to historical delivery information of a target client and a preset rule;
obtaining a historical delivery record of all clients matched with attribute information of the target client, and obtaining a priority of each type of delivery resources in the historical delivery record of all clients; and
determining a target delivery resource from the candidate delivery resources according to the priority of each type of delivery resources, and recommending the target delivery resource to the target client.

2. The recommendation method of claim 1, wherein, the historical delivery information of the target client comprises a historical delivery address, a shop address of the target client, and a historical delivery radius, and determining the candidate delivery resources according to the historical delivery information of the target client and the preset rule comprises at least one of:
determining delivery resources in an area where the historical delivery address locates as the candidate delivery resources; and, determining delivery resources in a circle area with a center of the shop address of the target client and a radius of the historical delivery radius as the candidate delivery resources.

3. The recommendation method of claim 1, wherein, the attribute information of the target client comprises an industry and a channel to which business operated by the target client belongs, and the priority of each type of delivery resources is a resource score of each type of delivery resources; and obtaining the historical delivery record of all the clients matched with the attribute information of the target client and obtaining the priority of each type of delivery resources in the historical delivery record of all client comprise:
obtaining a first client in the same industry as the target client, and obtaining a second client in the same channel as the target client;
obtaining a historical delivery record of the first client, obtaining a delivery number of each type of delivery resources and a total historical delivery number of all types of delivery resources according to the historical delivery record of the first client, and determining an industry score of each type of delivery resources;
obtaining a historical delivery record of the second client, obtaining a delivery number of each type of delivery resources and a total historical delivery number of all types of delivery resources according to the historical delivery record of the second client, and determining a channel score of each type of delivery resources; and
calculating a sum of the industry score and the channel score of each type of the delivery resources to determine a resource score of each type of delivery resources.

4. The recommendation method of claim 3, before calculating a sum of the industry score and the channel score of each type of delivery resources to determine a resource score of each type of delivery resources, further comprising:
obtaining advertisement data of non-outdoor advertisement delivered by the target client, advertisement data of non-outdoor advertisement delivered by clients other than the target client which are in the same industry as the target client, and advertisement data of non-outdoor advertisement delivered by clients other than the target client which are in the same channel as the target client;
determining a first similarity between the advertisement data of non-outdoor advertisement delivered by the target client and the advertisement data of non-outdoor advertisement delivered by the clients other than the target client which are in the same industry as the target client, and adjusting a preset first basis score according to the first similarity to obtain an industry basis score; and
determining a second similarity between the advertisement data of non-outdoor advertisement delivered by the target client and the advertisement data of non-outdoor advertisement delivered by the clients other than the target client which are in the same channel as the target client, adjusting a preset second basis score according to the second similarity to obtain a channel basis score; and
calculating a sum of the industry score and the channel score of each type of delivery resource to determine the source rescore of each type of delivery resources comprises:
determining the resource score of each type of delivery resources based on a preset calculation rule according to the industry basis score, the channel basis score, the industry score of each type of delivery resources and the channel score of each type of delivery resources.

5. The recommendation method of claim 3, wherein, determining the target delivery resource from the candidate delivery resources according to the priority of each type of delivery resources comprises:
dividing the candidate delivery resources into a plurality of delivery resource packages based on a preset combination rule;
calculating a sum of resource scores of respective types of delivery resources in each delivery resource package according to the resource score of each type of delivery resources, and determining total scores of respective delivery resource packages; and
sorting the plurality of delivery resource packages in a descending order of the total scores, and selecting top-N delivery resource packages as the target delivery resource, in which N is a preset positive integer.

6. The recommendation method of claim 4, wherein, determining the target delivery resource from the candidate delivery resources according to the priority of each type of delivery resources comprises:
dividing the candidate delivery resources into a plurality of delivery resource packages based on a preset combination rule;
calculating a sum of resource scores of respective types of delivery resources in each delivery resource package according to the resource score of each type of delivery resources, and determining total scores of respective delivery resource packages; and
sorting the plurality of delivery resource packages in a descending order of the total scores, and selecting top-N delivery resource packages as the target delivery resource, in which N is a preset positive integer.

7. The recommendation method of claim 1, after recommending the target delivery resource to the target client, further comprising:
obtaining purchase information of the target delivery resource delivered by the target client; and
determining and recording a delivery preference based on the purchase information.

8. A recommendation apparatus for a delivery resource of an outdoor advertisement, comprising:
one or more processors;
a memory storing instructions executable by the one or more processors;
wherein the one or more processors are configured to:
determine candidate delivery resources according to historical delivery information of a target client and a preset rule;
obtain a historical delivery record of all clients matched with attribute information of the target client, and to obtain a priority of each type of delivery resources in the historical delivery record of all clients;
determine a target delivery resource from the candidate delivery resources according to the priority of each type of delivery resources; and
recommend the target delivery resource to the target client.

9. The recommendation apparatus of claim 8, wherein, the historical delivery information of the target client comprises a historical delivery address, a shop address of the target client, and a historical delivery radius, and the one or more processors determine the candidate delivery resources according to the historical delivery information of the target client and the preset rule by performing at least one act of:
determining delivery resources in an area where the historical delivery address locates as the candidate delivery resources; and, determining delivery resources in a circle area with a center of the shop address of the target client and a radius of the historical delivery radius as the candidate delivery resources.

10. The recommendation apparatus of claim 8, wherein, the attribute information of the target client comprises an industry and a channel to which business operated by the target client belongs, and the priority of each type of delivery resources is a resource score of each type of delivery resource; and the one or more processors obtain the historical delivery record of all the clients matched with the attribute information of the target client and obtain the priority of each type of delivery resources in the historical delivery record of all client by performing acts of:
obtaining a first client in the same industry as the target client, and obtaining a second client in the same channel as the target client;
obtaining a historical delivery record of the first client, obtaining a delivery number of each type of delivery resources and a total historical delivery number of all types of delivery resources according to the historical delivery record of the first client, and determining an industry score of each type of delivery resources;
obtaining a historical delivery record of the second client, obtaining a delivery number of each type of delivery resources and a total historical delivery number of all types of delivery resources according to the historical delivery record of the second client, and determining a channel score of each type of delivery resources; and
calculating a sum of the industry score and the channel score of each type of the delivery resources to determine a resource score of each type of delivery resources.

11. The recommendation apparatus of claim 10, wherein, the one or more processors are configured to:
obtain advertisement data of non-outdoor advertisement delivered by the target client, advertisement data of non-outdoor advertisement delivered by clients other than the target client which are in the same industry as the target client, and advertisement data of non-outdoor advertisement delivered by clients other than the target client which are in the same channel as the target client;
determine a first similarity between the advertisement data of non-outdoor advertisement delivered by the target client and the advertisement data of non-outdoor advertisement delivered by the clients other than the target client which are in the same industry as the target client, to adjust a preset first basis score according to the first similarity to obtain an industry basis score; and to determine a second similarity between the advertisement data of non-outdoor advertisement delivered by the target client and the advertisement data of non-outdoor advertisement delivered by the clients other than the target client which are in the same channel as the target client, and to adjust a preset second basis score according to the second similarity to obtain a channel basis score; and
determine the resource score of each type of delivery resources based on a preset calculation rule according to the industry basis score, the channel basis score, the industry score of each type of delivery resources and the channel score of each type of delivery resources.

12. The recommendation apparatus of claim 10, wherein, the one or more processors determine the target delivery resource from the candidate delivery resources according to the priority of each type of delivery resources by performing acts of:
dividing the candidate delivery resources into a plurality of delivery resource packages based on a preset combination rule;
calculating a sum of resource scores of respective types of delivery resources in each delivery resource package according to the resource score of each type of delivery resources, and determining total scores of respective delivery resource packages; and
sorting the plurality of delivery resource packages in a descending order of the total scores, and selecting top-N delivery resource packages as the target delivery resource, in which N is a preset positive integer.

13. The recommendation apparatus of claim 8, wherein the one or more processors are configured to:
obtain purchase information of the target delivery resource delivered by the target client; and
determine and to record a delivery preference based on the purchase information.

14. A non-temporary computer readable storage medium having a computer program stored thereon, wherein, when the computer program is executed by a processor, the recommendation method for a delivery resource of an outdoor advertisement, in which the method comprises:
determining candidate delivery resources according to historical delivery information of a target client and a preset rule;
obtaining a historical delivery record of all clients matched with attribute information of the target client, and obtaining a priority of each type of delivery resources in the historical delivery record of all clients; and
determining a target delivery resource from the candidate delivery resources according to the priority of each type of delivery resources, and recommending the target delivery resource to the target client.
